(19) United States
(12) Patent Application Publication
(10) Pub. No.: US 2016/0147321 A1
(43) Pub. Date: May 26, 2016

(54) PORTABLE ELECTRONIC DEVICE

(71) Applicants: Inventec (Pudong) Technology Corporation, Shanghai City (CN); INVENTEC CORPORATION, Taipei City (TW)

(72) Inventors: Lung-Hsun SONG, Taipei City (TW); Chun-Chi LIN, Taipei City (TW); Chun-Yuan HUANG, Taipei City (TW)

(21) Appl. No.: 14/691,199

(22) Filed: Apr. 20, 2015

(30) Foreign Application Priority Data
Nov. 26, 2014 (CN) 201410696040.4

(51) Int. Cl. G06F 3/0354; G06F 3/0481

(52) U.S. Cl. CPC G06F 3/03547; G06F 3/04817

(57) ABSTRACT

The present invention provides a portable electronic device having a first surface, a second surface opposite to the first surface. The portable electronic device includes a screen, a cursor control unit, and a control module. The screen is on the first surface. The cursor controlling unit is on the second surface for generating a cursor signal. The control module is electrically connected with the screen and the cursor control unit and controls the screen to display a cursor according to the cursor signal. The cursor signal includes a pressing signal. The control module further determines whether a single click, a double click, or a long click is executed according to the pressing signal, and executes the corresponding procedure accordingly.

### CROSS-REFERENCE TO RELATED APPLICATIONS

This non-provisional application claims priority under 35 U.S.C. §119(a) on Patent Application No. 201410696040.4 filed in China on Nov. 26, 2014, the entire contents of which are hereby incorporated by reference.

### BACKGROUND OF THE INVENTION

1. Technical Field of the Invention

The present invention relates to a portable electronic device, particularly to a portable electronic device with a cursor control unit on the back.

2. Description of the Related Art

Due to the advance of modern technology, tablets or handheld devices in the market are getting larger and larger and the weight of the device is also increasing accordingly. Usually the user operates the handheld device by holding the device with one hand and operating the touch screen with the other hand. However, the weight of the current tablet or handheld device is about one kilogram, and is not suitable for a single hand to hold and operate. Therefore, how to develop the portable device for holding and operating at the same time is an urgent problem.

### SUMMARY OF THE INVENTION

A portable electronic device having a first surface and a second surface opposite to the first surface is provided. The portable electronic device includes a screen, a cursor control unit, and a control module. The screen is on the first surface. The cursor control unit is on the second surface for generating a cursor signal. The control module is electrically connected with the screen and the cursor control unit, and used for controlling the screen to display a cursor according to the cursor signal.

In an embodiment, the cursor control unit is a touch panel or a track point.

In an embodiment, the cursor signal comprises a pressing signal comprising a signal starting point and a signal ending point, and the control module determines whether a single click, a double click or a long click is performed on the cursor control unit according to the pressing signal within a first interval, and then executes a corresponding procedure.

In an embodiment, the control module determines the single click is performed, if the pressing signal appears only one time within the first interval and a period between the signal starting point and the signal ending point is shorter than the first interval.

In an embodiment, the control module determines the double click is performed, if the pressing signals appears a plurality of times within the first interval and a period between the signal starting point of each pressing signal and the signal ending point of each pressing signal is shorter than the first interval.

In an embodiment, the control module determines the long click is performed, if the pressing signal appears only one time within the first interval and a period between the signal starting point and the signal ending point is longer than or equal to the first interval.

In an embodiment, the control module controls the screen to display a plurality of virtual buttons according to a button-display signal.

In an embodiment, the button-display signal is generated by the cursor control unit.

In an embodiment, the portable electronic device further includes a shortcut key electrically connected with the control module for generating the button-display signal after being pressed.

In an embodiment, the plurality of virtual buttons at least comprise a first virtual button and a second virtual button, and the first virtual button stands for the left mouse button and the second virtual button stands for the right mouse button.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a diagram of the first surface of the portable electronic device according to an embodiment of the present invention.

FIG. 2 is a diagram of the second surface of the portable electronic device according to an embodiment of the present invention.

FIG. 3 is a diagram of the pressing the cursor control unit according to an embodiment of the present invention.

FIG. 4 is a flowchart of the pressing the cursor control unit according to an embodiment of the present invention.

FIG. 5 is a diagram explaining the pressing signal is a single click according to an embodiment of the present invention.

FIG. 6 is a diagram explaining the pressing signal is a double click according to an embodiment of the present invention.

FIG. 7 is a diagram explaining the pressing signal is a long click according to an embodiment of the present invention.

FIG. 8 is a diagram of the virtual button according to an embodiment of the present invention.

FIG. 9 is a diagram of pressing the shortcut key to display the virtual button according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

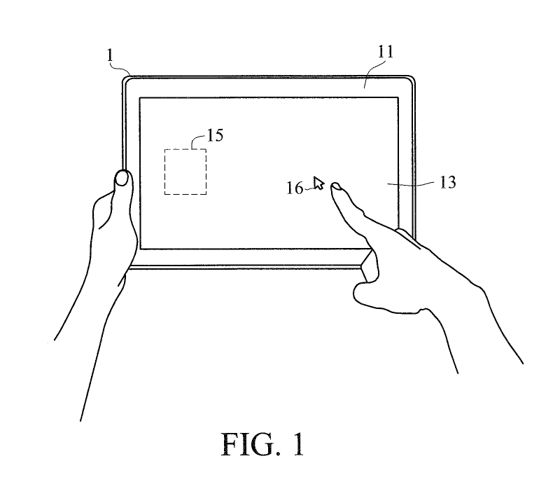

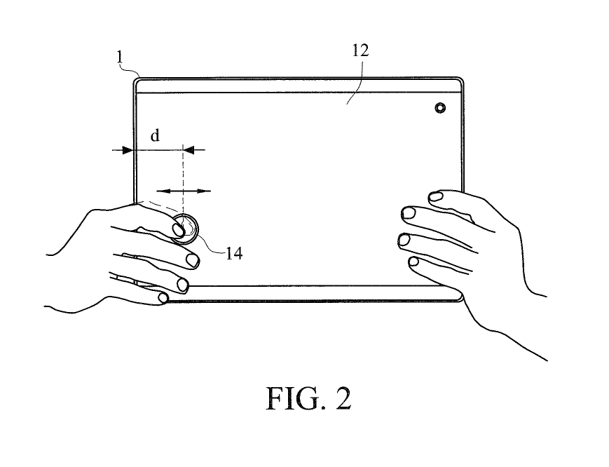

Please refer to FIG. 1 and FIG. 2. FIG. 1 is a diagram of the first surface of the portable electronic device according to an embodiment of the present invention. FIG. 2 is a diagram of the second surface of the portable electronic device according to an embodiment of the present invention. As shown in FIG. 1 and FIG. 2, the portable electronic device 1 of the present invention has a first surface 11 and a second surface 12 opposite to the first surface 11. The portable electronic device 1 includes a screen 13, a cursor control unit 14, and a control module 15. The screen 13 is on the first surface 11. The cursor control unit 14 is on the second surface 11 for generating a cursor signal. The control module 15 is disposed inside the portable electronic device 1 and electrically connected with the screen 13 and the cursor control unit 14 for controlling the screen 13 to display a cursor 16 according to the cursor signal.

In an embodiment of the present invention, the function of the cursor control unit 14 is controlling the cursor 16 displayed on the screen 13. The cursor control unit 14 is, but not limited to, a touch panel, a track point, a track ball, or any other electronic component capable of controlling the cursor. The location of the cursor control unit 14 is close to the left or right side of the second surface 12. Specifically, the distance d between the cursor control unit 14 and one side of the second surface 12 is shorter than a default distance, and the default distance is designed by persons skilled in the art according to the spirit of the present invention. For example, the width of an adult's palm is about 20 centimeters, so the default distance is set to 5 to 10 centimeters. Therefore, the user easily touches and uses the cursor control unit 14 when holding the portable electronic device 1 of the present invention. The screen 13 is but not limited to a common display or a touch screen.

For example, the first surface 11 is the front side of the portable electronic device 1 and has a screen 13 for displaying the contents of the display device and interacting with the user. The second surface 12 is the back side of the portable electronic device 1 and has a touch panel for users to control the cursor 16 displayed on the screen 13. In other words, the touch panel replaces the functions of a mouse configured to a conventional computer. When the user holds the portable electronic device of the present invention, the method for operating the portable electronic device is to grab the portable electronic device with two palms and operate on the touch panel disposed on the back with an idle finger to move the cursor 16 instead of grabbing the portable electronic device with a single hand and operating the screen with the other hand.

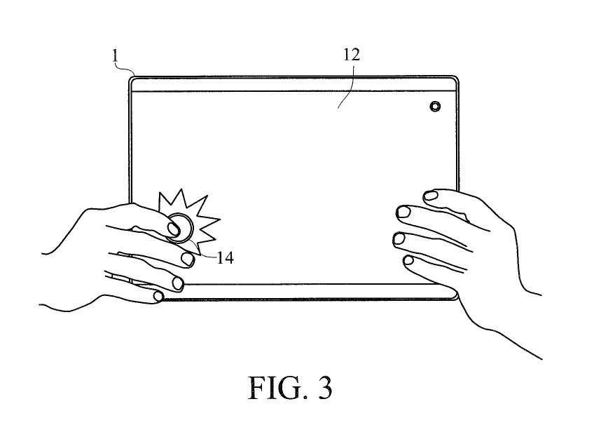

Please refer to FIG. 3. FIG. 3 is a diagram of the pressing the cursor control unit according to an embodiment of the present invention. As shown in FIG. 3, in an embodiment of the present invention, when the user operates the cursor control unit 14 on the second surface 12, the cursor signal generates a pressing signal and the pressing signal includes a signal starting point and a signal ending point. The control module further determines whether a single click, a double click, or a long click is performed on the cursor control unit according to the pressing signal within a first interval, and then executes a corresponding procedure.

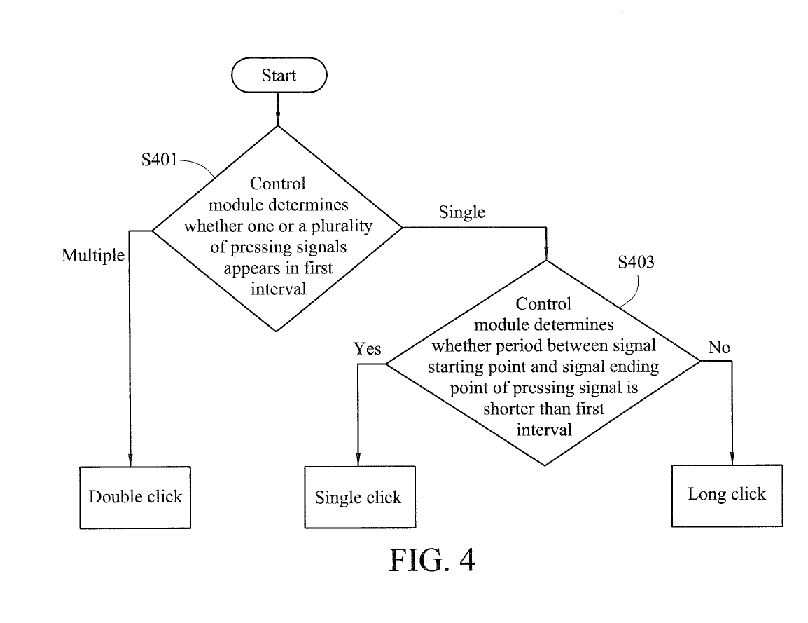

In association with determining whether a single click, a double click, or a long click is performed on the cursor control unit, please refer to FIG. 4. FIG. 4 is a flowchart of the pressing the cursor control unit according to an embodiment of the present invention. As shown in FIG. 4, in the step S401, the control module determines whether one or a plurality of pressing signals appear in a first interval. In the step S403, the control module determines whether a period between the signal starting point and the signal ending point of the pressing signal is shorter than the first interval.

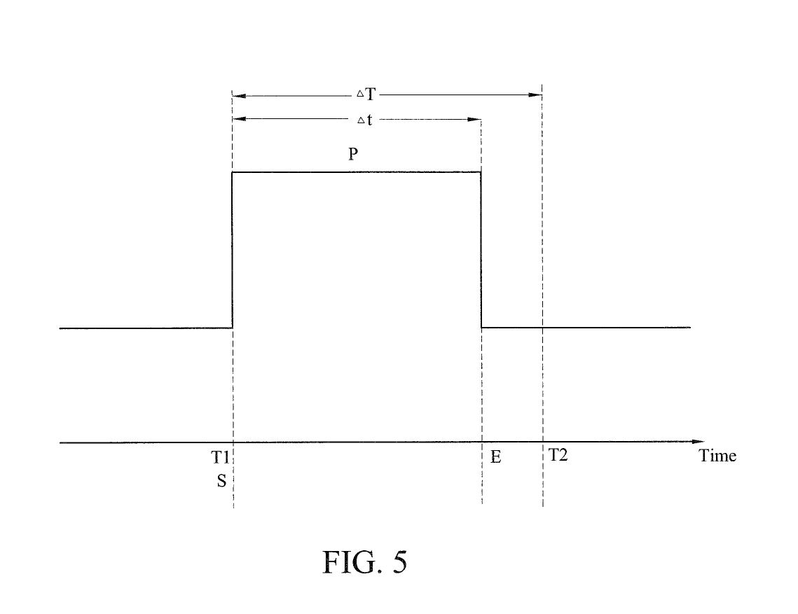

In an embodiment of the present invention, the control module determines a single click is performed when only one pressing signal appears within the first interval and a period between the signal starting point and the signal ending point of the pressing signal is shorter than the first interval. Please refer to FIG. 5. FIG. 5 is a diagram explaining the pressing signal is a single click according to an embodiment of the present invention. As shown in FIG. 5, when the user presses the cursor control unit, a pressing signal P is generated and the signal starting point of the pressing signal P is S and the signal ending point of the pressing signal P is E. The control module starts counting the first interval from the signal starting point S. The first interval indicates the period ΔT from the time point T1 to the time point T2 in the figure. In FIG. 5, the period Δt from the signal starting point S to the signal ending point E is shorter than the first interval ΔT, so the control module determines that a single click is performed. Specifically, the first interval ΔT starts from the time point T1 of the signal starting point S.

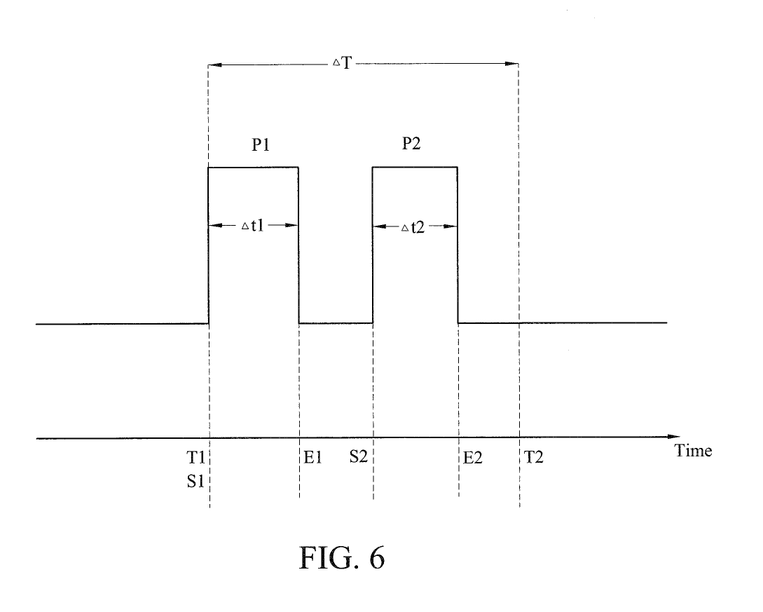

The control module determines a double click is performed when a plurality of pressing signals appear within the first interval and a period between the signal starting point and the signal ending point of the plurality of pressing signals is shorter than the first interval. Please refer to FIG. 6. FIG. 6 is a diagram explaining the pressing signal is a double click according to an embodiment of the present invention. As shown in FIG. 6, when the user double clicks the cursor control unit, two pressing signals P1 and P2 are generated and the signal starting points of the pressing signals P1 and P2 are S1 and S2, and the signal ending points of the pressing signals P1 and P2 are E1 and E2. The periods of the pressing signals P1 and P2 are Δt1 and Δt2. The control module starts counting the first interval from the first signal starting point S1. The first interval indicates the period ΔT from the time point T1 to the time point T2 in the figure. In FIG. 6, the two pressing signals P1 and P2 both appear within the first interval ΔT, and the periods of P1 and P2, Δt1 and Δt2, are both shorter than the first interval ΔT, so the control module determines that a double click is performed.

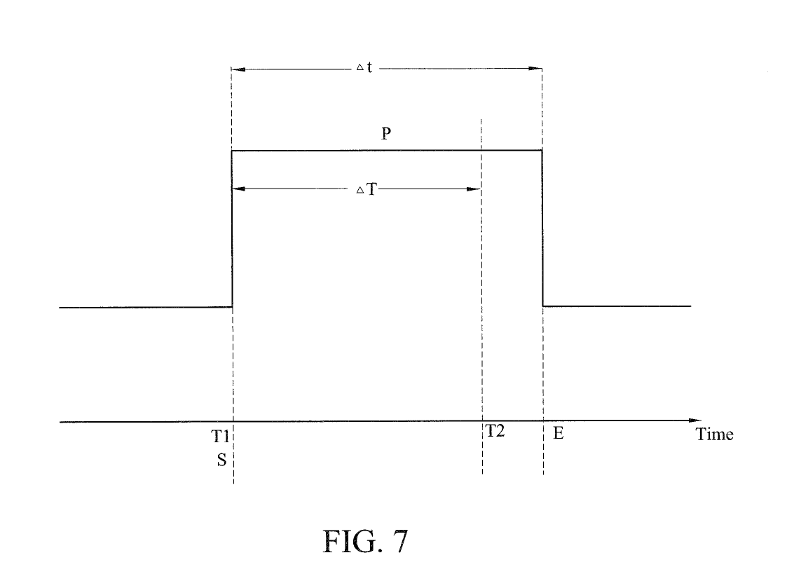

The control module determines a long click is performed when only one pressing signal appears within the first interval and a period between the signal starting point and the signal ending point of the pressing signal is longer than or equal to the first interval. Please refer to FIG. 7. FIG. 7 is a diagram explaining the pressing signal is a long click according to an embodiment of the present invention. As shown in FIG. 7, when the user presses the cursor control unit, a pressing signal P is generated and the signal starting point of the pressing signal P is S and the signal ending point of the pressing signal P is E. The control module starts counting the first interval from the signal starting point S. The first interval indicates the period ΔT from the time point T1 to the time point T2 in the figure. In FIG. 7, the period Δt from the signal starting point S to the signal ending point E is longer than the first interval ΔT, so the control module determines a long click is performed.

The single click, the double click, and the long click and the general actions of mouse are in one-to-one correspondence. For example, the single click corresponds to the left mouse button, so single clicking the cursor control unit equals to clicking the left mouse button for selecting a file or a window. The double click corresponds to the right mouse button, so double clicking the cursor control unit equals to clicking the right mouse button for checking the file property. The long click corresponds to editing, so the user long clicks the cursor control unit equals editing for editing files. The above corresponding operating procedures of the cursor control unit are freely designed by the designer and the embodiment is for illustrating but not for limiting the present invention.

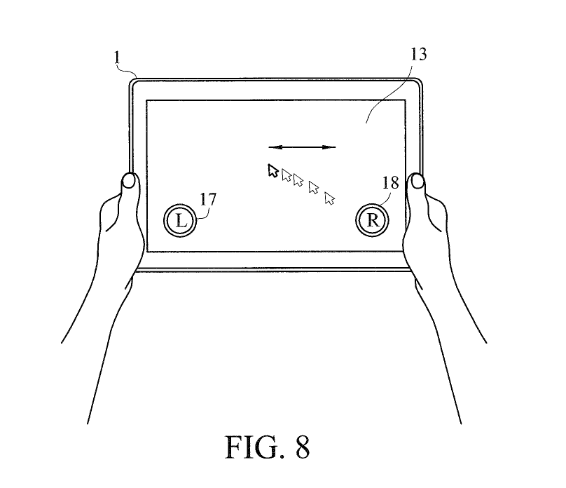

In addition, in an embodiment of the present invention, the control module controls the screen to display a plurality of virtual buttons according to a button-display signal. The button-display signal is generated by the cursor control unit. Please refer to FIG. 8. FIG. 8 is a diagram of the virtual button according to an embodiment of the present invention. As shown in FIG. 8, when the cursor control unit on the back of the portable electronic device 1 is pressed, the screen 13 displays a first virtual button 17 and a second virtual button 18. In an embodiment, the first virtual button 17 stands for the left mouse button and the second virtual button 18 stands for the right mouse button.

Therefore, except pressing the cursor control unit in different methods to perform the single click, the double click, or the long click when the single click and the double click stands for the left mouse button and the right mouse button respectively, the functions of the left mouse button and the right mouse button are also performed by the first virtual button 17 and the second virtual button 18 on the screen 13 when the screen 13 is a touch screen. Therefore, the user operates the portable electronic device 1 with the two thumbs in a more convenient way. Besides, because the cursor control unit is a hardware electronic component and usually has a life time of usage, replacing part of the functions of the cursor control unit with the virtual buttons 17 and 18 also reduces the attrition rate and extends the life time of usage.

For example, except single click, double click, or long click the cursor control unit, the user also triple clicks the cursor control unit 14 to recall the first virtual button 17 and the second virtual button 18. The virtual buttons on the screen 13 is also arranged from top to bottom or in any other arrangement instead of left to right in FIG. 8. In addition, the button numbers and the functions of the virtual buttons are designed according to the user's need. The virtual buttons are but not limited to a virtual keyboard or other virtual input software in addition to the first and the second virtual button. The embodiment is for illustrating but not for limiting the present invention. For example, a virtual joystick direction buttons is displayed on the left side of the screen 13 and a plurality of virtual joystick functional buttons s are displayed on the right side of the screen, so the user easily uses the virtual buttons as a control interface for a video game when using the portable electronic device 1 to play games.

For example, in another embodiment of the present invention, the cursor control unit 14 includes the functions of moving the cursor and generating the button-display signal only. The user moves the cursor by simply operates the cursor control unit 14 to left or right, and the user performs single clicking on the cursor control unit 14 to recall the virtual buttons. The functions of the left mouse button, the right mouse button, and editing are performed by the virtual buttons. The functions of the cursor control unit 14 are designed according to the user's need and the embodiment is for illustrating but not for limiting the present invention.

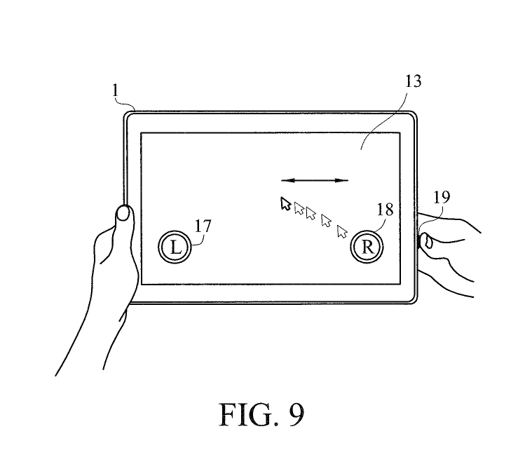

In another embodiment of the present invention, the portable electronic device comprises a shortcut key electrically connected with the control module for generating the button-display signal to control the screen to display a plurality of virtual buttons. Please refer to FIG. 9. FIG. 9 is a diagram of pressing the shortcut key to display the virtual button according to an embodiment of the present invention. As shown in FIG. 9, the right side of the portable electronic device 1 has a shortcut key 19. When the user wants to recall the virtual buttons, pressing the shortcut key 19 to recall a first virtual button 17 and a second virtual button 18 for performing the functions of the left mouse button and the right mouse button is also available except pressing the cursor control unit on the back.

In summary, the present invention provides a portable electronic device having a cursor control unit on the back to operate the cursor displayed on the screen. The operations and the functions of the conventional mouse are in one-to-one correspondence to the operations of the portable electronic device. Besides, the user recalls the virtual buttons displayed on the screen by the defined operations of the cursor control unit or by pressing the shortcut key, so that the user operates the cursor when both two hands holds the device without leaving the hands off the device and the usability is enhanced.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A portable electronic device having a first surface and a second surface opposite to the first surface, the portable electronic device comprising:
a screen on the first surface;
a cursor control unit on the second surface for generating a cursor signal; and
a control module electrically connected with the screen and the cursor control unit, and used for controlling the screen to display a cursor according to the cursor signal.

2. The portable electronic device of claim 1, wherein the cursor control unit is a touch panel or a track point.

3. The portable electronic device of claim 1, wherein the cursor signal comprises a pressing signal comprising a signal starting point and a signal ending point, and the control module determines whether a single click, a double click or a long click is performed on the cursor control unit according to the pressing signal within a first interval, and then executes a corresponding procedure.

4. The portable electronic device of claim 3, wherein the control module determines the single click is performed, if the pressing signal appears only one time within the first interval and a period between the signal starting point and the signal ending point is shorter than the first interval.

5. The portable electronic device of claim 3, wherein the control module determines the double click is performed, if the pressing signals appears a plurality of times within the first interval and a period between the signal starting point of each pressing signal and the signal ending point of each pressing signal is shorter than the first interval.

6. The portable electronic device of claim 3, wherein the control module determines the long click is performed, if the pressing signal appears only one time within the first interval and a period between the signal starting point and the signal ending point is longer than or equal to the first interval.

7. The portable electronic device of claim 1, wherein the control module controls the screen to display a plurality of virtual buttons according to a button-display signal.

8. The portable electronic device of claim 7, wherein the button-display signal is generated by the cursor control unit.

9. The portable electronic device of claim 7, further comprising a shortcut key electrically connected with the control module for generating the button-display signal after being pressed.

10. The portable electronic device of claim 7, wherein the plurality of virtual buttons at least comprise a first virtual button and a second virtual button, and the first virtual button stands for the left mouse button and the second virtual button stands for the right mouse button.
